(19) United States
(12) Patent Application Publication
(10) Pub. No.: US 2018/0350094 A1
(43) Pub. Date: Dec. 6, 2018

(54) TARGET RECOGNITION SYSTEM, TARGET RECOGNITION METHOD, AND STORAGE MEDIUM

(71) Applicant: HONDA MOTOR CO., LTD., Tokyo (JP)

(72) Inventors: Daihan Wang, Wako-shi (JP); Hiroshi Miura, Wako-shi (JP)

(21) Appl. No.: 15/990,864

(22) Filed: May 29, 2018

(30) Foreign Application Priority Data
May 31, 2017 (JP) 2017-107855

(51) Int. Cl. G06T 7/70; G06T 7/292; G06K 9/00; G01P 3/38; G01S 13/89

(52) U.S. Cl. CPC G06T 7/70; G06T 7/292; G01S 13/89; G01P 3/38; G06K 9/00805

(57) ABSTRACT

A target recognition system includes a first recognition device that recognizes a position and a speed of a target, a second recognition device that recognizes a position and a speed of a target and to be different from the first recognition device, a first processing unit that determines whether a first target recognized by the first recognition device and a second target recognized by the second recognition device are the same target, and correlates the first target and the second target with each other when it is determined that the first target and the second target are the same target, and a second processing unit that predicts future positions and speeds of the first target and the second target correlated with each other by the first processing unit, wherein the first processing unit determines whether a state of the first recognition device or the second recognition device is a predetermined state on the basis of a prediction result of the second processing unit and recognition results of the first recognition device and the second recognition device.

### CROSS-REFERENCE TO RELATED APPLICATION

Priority is claimed on Japanese Patent Application No. 2017-107855, filed May 31, 2017, the content of which is incorporated herein by reference.

### BACKGROUND OF THE INVENTION

### Field of the Invention

The present invention relates to a target recognition system, a target recognition method, and a storage medium.

### Description of Related Art

In the related art, a technology for recognizing an object in front of a host vehicle is known (for example, see Japanese Unexamined Patent Application, First Publication No. 7-182484).

### SUMMARY OF THE INVENTION

However, in the related art, erroneous recognition of an object has not been sufficiently reviewed. As a consequence, there are cases where it is not possible to accurately recognize an object.

An aspect of the present invention has been made to solve the above problem and an object of the present invention is to provide a target recognition system, a target recognition method, and a storage medium, by which it is possible to improve accuracy of recognition of a target while improving a processing speed.

A target recognition system, a target recognition method, and a storage medium according to the invention employ the following configurations.

(1) An aspect of the invention is a target recognition system including a first recognition device that recognizes a position and a speed of a target, a second recognition device that recognizes a position and a speed of a target and is different from the first recognition device, a first processing unit that determines whether a first target recognized by the first recognition device and a second target recognized by the second recognition device are the same target, and correlates the first target and the second target with each other when it is determined that the first target and the second target are the same target, and a second processing unit that predicts future positions and speeds of the first target and the second target correlated with each other by the first processing unit, wherein the first processing unit determines whether a state of the first recognition device or the second recognition device is a predetermined state on the basis of a prediction result of the second processing unit and recognition results of the first recognition device and the second recognition device.

(2) In the target recognition system of the aspect of (1), the first processing unit determines whether the recognition results of the first recognition device and the second recognition device coincide with the prediction result of the second processing unit, and when any one of the recognition results of the first recognition device and the second recognition device does not coincide with the prediction result of the second processing unit, the first processing unit determines that a recognition device, which has the recognition result not coinciding with the prediction result of the second processing unit, is in the predetermined state.

(3) In the target recognition system of the aspect of (1) or (2), on the basis of a prediction result of the second processing unit at a first timing and recognition results of the first recognition device and the second recognition device at a second timing after the first timing, the second processing unit further derives a speed and a position of a target recognized at the second timing, and wherein the target recognition system further includes an information management unit configured to store a derivation result of the second processing unit in a storage unit according to a determination result of the first processing unit, and, on the basis of information stored in the storage unit by the information management unit, the second processing unit predicts future position and speed of the target recognized at the second timing.

(4) In the target recognition system of the aspect of any one of (1) to (3), when it is determined by the first processing unit that any one of the first recognition device and the second recognition device is in the predetermined state, the second processing unit predicts future position and speed of the target on the basis of a recognition result of a recognition device determined not to be in the predetermined state.

(5) In the target recognition system of the aspect of any one of (1) to (4), the first recognition device includes a camera, an image recognition part configured to recognize a target by analyzing an image of the camera, and a radar configured to recognize a target on the basis of electromagnetic waves reflected by the target, wherein the first recognition device outputs, to the first processing unit, a position and a speed of a target determined as the same target between the targets recognized by the image recognition part and the radar.

(6) In the target recognition system of the aspect of any one of (1) to (5), the second recognition device includes a camera, an image recognition part configured to recognize the target by analyzing an image of the camera, and a finder configured to recognize the target on the basis of reflected waves of light projected to the target, the reflected waves being reflected by the target, wherein the second recognition device outputs, to the first processing unit, a position and a speed of a target determined as the same target between the targets recognized by the image recognition part and the finder.

(7) Another aspect of the invention is a target recognition method causing an in-vehicle computer, which is installed in a vehicle including a first recognition device that recognizes a position and a speed of a target and a second recognition device that recognizes a position and a speed of a target and is different from the first recognition device, to perform determining whether a first target recognized by the first recognition device and a second target recognized by the second recognition device are the same target, correlating the first target and the second target with each other when it is determined that the first target and the second target are the same target, predicting future positions and speeds of the first target and the second target correlated with each other, and determining whether a state of the first recognition device or the second recognition device is a predetermined state on the basis of a prediction result of the future positions and speeds of the first target and the second target and recognition results of the first recognition device and the second recognition device.

(8) Another aspect of the invention is a storage medium stored with a program causing an in-vehicle computer, which is installed in a vehicle including a first recognition device that recognizes a position and a speed of a target and a second recognition device that recognizes a position and a speed of a target and is different from the first recognition device, to perform a step of determining whether a first target recognized by the first recognition device and a second target recognized by the second recognition device are the same target, a step of correlating the first target and the second target with each other when it is determined that the first target and the second target are the same target, a step of predicting future positions and speeds of the first target and the second target correlated with each other, and a step of determining whether a state of the first recognition device or the second recognition device is a predetermined state on the basis of a prediction result of the future positions and speeds of the first target and the second target and recognition results of the first recognition device and the second recognition device.

According to the aspects of (1), (2), (7), and (8), it is possible to improve accuracy of recognition of a target while improving a processing speed.

According to the aspect of (3), it is possible to further improve a processing speed.

According to the aspect of (4), when axes of the recognition devices are deviated from each other in a vertical direction, the axes are corrected to a correct value and detection values of sensors included in the recognition devices are subjected to fusion, so that it is possible to improve accuracy of recognition of a target after the axis deviation.

According to the aspect of (5), it is possible to further improve accuracy of recognition of a target.

According to the aspect of (6), it is possible to further improve accuracy of recognition of a target.

### BRIEF DESCRIPTION OF THE DRAWINGS

FIG. 1 is a configuration diagram of a target recognition system of a first embodiment.

FIG. 2 is a flowchart illustrating a series of processes of a target recognition system.

FIG. 3 is a diagram illustrating an example of a situation in which a recognition device is determined to be in a predetermined state.

FIG. 4 is a diagram illustrating an example of a situation in which a first target and a second target are determined as a non-recognized target.

FIG. 5 is a diagram illustrating an example of a situation in which a first target and a second target are determined as a recognized target.

FIG. 6 is a configuration diagram of a target recognition system of a second embodiment.

### DETAILED DESCRIPTION OF THE INVENTION

Hereinafter, embodiments of a target recognition system, a target recognition method, and a storage medium of the present invention will be described with reference to the drawings.

### First Embodiment

[System Configuration]

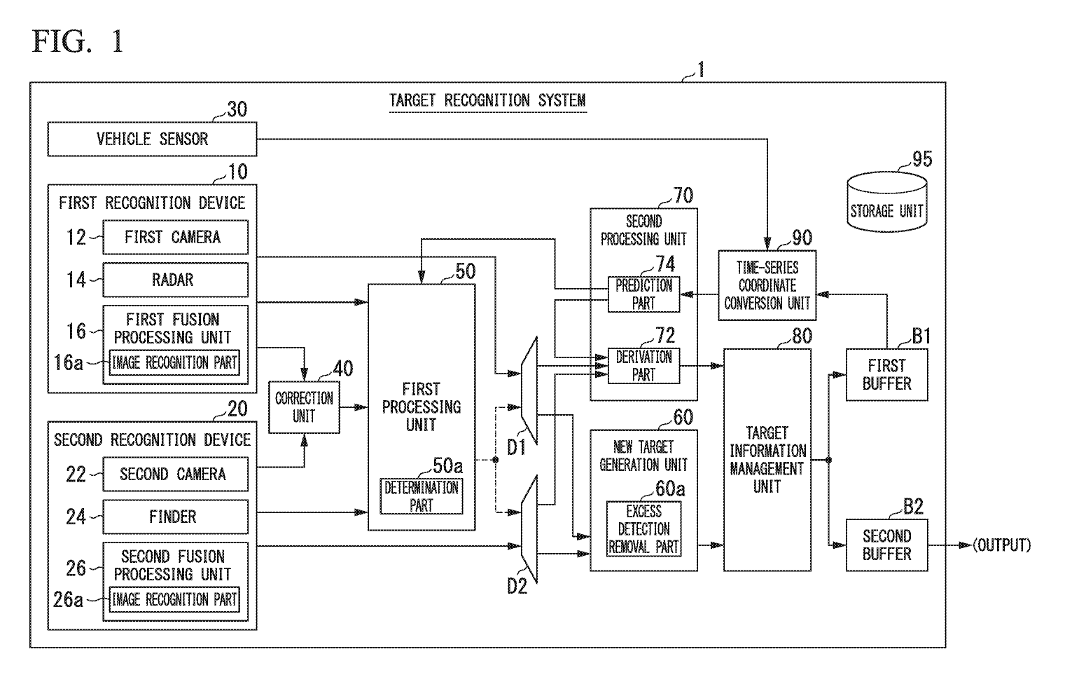

FIG. 1 is a configuration diagram of a target recognition system 1 of a first embodiment. The target recognition system 1 of the first embodiment, for example, is installed in a vehicle (hereinafter, referred to as a host vehicle M) with two wheels, three wheels, four wheels and the like. The host vehicle M, for example, is driven by an internal combustion engine such as a diesel engine and a gasoline engine, an electric motor, or a driving source obtained by combining them with each other. The electric motor operates by using power generated by a generator connected to the internal combustion engine or power discharged from a secondary cell or a fuel cell.

The target recognition system 1, for example, includes a first recognition device 10, a second recognition device 20, a vehicle sensor 30, a correction unit 40, a first processing unit 50, a new target generation unit 60, a second processing unit 70, a target information management unit 80, a time-series coordinate conversion unit 90, a storage unit 95, a first distributor D1, a second distributor D2, a first buffer B1, and a second buffer B2. The target recognition system 1 may have a configuration not including the first recognition device 10, the second recognition device 20, and the vehicle sensor 30 among the aforementioned plurality of elements.

The aforementioned elements (functional units), except for the first recognition device 10, the second recognition device 20, the vehicle sensor 30, and the storage unit 95, for example, are implemented when a processor such as a central processing unit (CPU) executes a program (software). Some or all of the elements may be implemented by hardware such as a large scale integration (LSI), an application specific integrated circuit (ASIC), and a field-programmable gate array (FPGA), or may be implemented by the software and the hardware in cooperation.

The storage unit 95, for example, is implemented by a storage device such as a hard disk drive (HDD), a flash memory, a random access memory (RAM), and a read only memory (ROM). The storage unit 95, for example, stores the program executed by the processor.

The elements (various devices and equipments) included in the target recognition system 1 are connected to one another via a multiplex communication line such as a controller area network (CAN) communication line, a serial communication line, a wireless communication network and the like. Information transfer among the functional units by the program is performed by writing information in a shared area of a memory or a register.

The first recognition device 10, for example, includes a first camera 12, a radar 14, and a first fusion processing unit 16. The first camera 12, for example, is a digital camera using a solid-state imaging element such as a charge coupled device (CCD) and a complementary metal oxide semiconductor (CMOS). One or a plurality of first cameras 12 are mounted at arbitrary places of the host vehicle M. In the case of capturing an image of an area in front of the host vehicle M, the first camera 12 is mounted at an upper part of a front windshield, on a rear surface of a rear-view mirror, and the like. The first camera 12, for example, periodically and repeatedly captures an image of an area in the vicinity of the host vehicle M. The first camera 12 may be a stereo camera.

The radar 14 emits radio waves such as millimeter waves to the vicinity of the host vehicle M, detects radio waves (reflected waves) reflected by a target, and recognizes at least a position (a distance and an orientation) of the target. One or a plurality of radars 14 are mounted at arbitrary places of the host vehicle M. The radar 14 may recognize the position and the speed of the target by a frequency modulated continuous wave (FM-CW) scheme, or recognize the speed on the basis of a temporal change in the recognized position of the target.

The first fusion processing unit 16 includes an image recognition part (an image processing part) 16a. The image recognition part 16a may be a subsidiary constituent of the first camera 12. The image recognition part 16a analyzes an image captured by the first camera 12 and recognizes a position and a speed of a target. The first fusion processing unit 16, for example, performs a sensor fusion process on recognition results of the first camera 12/the image recognition part 16a and the radar 14, thereby deriving the position, the speed, the type (for example, the type of a vehicle, a pedestrian, a guardrail and the like), a delay amount and the like of the target. The position of the target, for example, is expressed by coordinates and the like in a space (hereinafter, referred to as a virtual three-dimensional space) corresponding to a real space (a space based on width, depth, and height) where the host vehicle M is located.

The first fusion processing unit 16 gives a target ID for identifying targets from one another to each target from which its position, speed and the like are to be derived. The first fusion processing unit 16 outputs, to the correction unit 40 and the first distributor D1, information (hereinafter, referred to as first target information) including a position, a speed, a type, a delay amount, a recognition time (an execution time of a sensor fusion process) and the like of each target corresponding to the target ID, and further outputs the information on the speed of the target to the first processing unit 50. A description will be given on the assumption that the first recognition device 10 recognizes one target at one time; however, the first recognition device 10 may simultaneously recognize a plurality of targets. The second recognition device 20 is also the same.

The second recognition device 20, for example, includes a second camera 22, a finder 24, and a second fusion processing unit 26. The second camera 22, for example, is a digital camera using a solid-state imaging element such as a CCD and a CMOS, similarly to the first camera 12. One or a plurality of second cameras 22 are mounted at arbitrary places of the host vehicle M. The second camera 22, for example, periodically and repeatedly captures an image of an area in the vicinity of the host vehicle M. The second camera 22 may be a stereo camera.

The finder 24 is a light detection and ranging (LIDAR) that measures scattered light for irradiation light and recognizes a position and a speed of a target by using at least a part of an outline of the target. One or a plurality of finders 24 are mounted at arbitrary places of the host vehicle M.

The second fusion processing unit 26 includes an image recognition part (an image processing part) 26a. The image recognition part 26a may be a subsidiary constituent of the second camera 22. The image recognition part 26a analyzes an image captured by the second camera 22 and recognizes a position and a speed of a target. The second fusion processing unit 26, for example, performs a sensor fusion process on recognition results of the second camera 22/the image recognition part 26a and the finder 24, thereby deriving the position (a position in a virtual three-dimensional space), the speed, a type, a shape, a delay amount and the like of the target. The second fusion processing unit 26 gives a target ID to each target from which its position, speed and the like are to be derived. The second fusion processing unit 26 outputs, to the correction unit 40 and the second distributor D2, information (hereinafter, referred to as second target information) including a position, a speed, a shape, a type, a delay amount, a recognition time and the like of each target corresponding to the target ID, and further outputs the information on the speed of the target to the first processing unit 50.

The vehicle sensor 30, for example, includes a vehicle speed sensor that detects a speed of the host vehicle M, an acceleration sensor that detects an acceleration, a yaw rate sensor that detects an angular velocity around a vertical axis, a direction sensor that detects a direction of the host vehicle M, and the like. The vehicle sensor 30 outputs information indicating detection results detected by each sensor to the time-series coordinate conversion unit 90.

With reference to the first target information and the second target information, the correction unit 40 performs correction for temporally synchronizing the positions of the targets included in the information with each other. It is assumed that for example, the first fusion processing unit 16 of the first recognition device 10 repeatedly performs a sensor fusion process at a predetermined cycle (hereinafter, referred to as a first cycle) and outputs the first target information to the correction unit 40 at all such times, and the second fusion processing unit 26 of the second recognition device 20 repeatedly performs a sensor fusion process at a cycle (hereinafter, referred to as a second cycle) shorter or longer than the first cycle and outputs the second target information to the correction unit 40 at all such times. In this case, a target is not always recognized at the same time and target information of a target recognized at different times may be output to the correction unit 40. Accordingly, with reference to the recognition times of the target information input from the first recognition device 10 and the second recognition device 20, the correction unit 40 corrects the positions and the speeds of the recognized targets in order to synchronize the information with each other. In this case, the correction unit 40 performs a process such as linear interpolation according to necessity, and corrects position information in one or both of the first target information and the second target information to information recognized at a reference timing.

The first processing unit 50 determines whether the target (hereinafter, referred to as a first target) recognized by the first recognition device 10 and the target (hereinafter, referred to as a second target) recognized by the second recognition device 20 are the same target on the basis of the target information (target information with corrected position and speed of the target) input from the correction unit 40, the information on the speeds of the targets input from the first recognition device 10 and the second recognition device 20, and information input from the second processing unit 70 to be described later. When the targets are determined as the same target, the first processing unit 50 correlates the targets determined as the same target with each other. The “correlating”, for example, indicates that identification information (a common target ID) indicating one target is given to two targets.

Moreover, the first processing unit 50 determines whether each of the first target and the second target is a target recognized in the past (hereinafter, referred to as a recognized target), and outputs a control signal (a dashed arrow of the drawing) for switching output destinations of the first distributor D1 and the second distributor D2, on the basis of the determination result.

When it is determined that the first target is a recognized target, the first processing unit 50 allows the first distributor D1 to output the first target information input from the first recognition device 10 to the second processing unit 70, and when it is determined that the first target is not a recognized target, the first processing unit 50 allows the first distributor D1 to output the first target information input from the first recognition device 10 to the new target generation unit 60. In this case, the first processing unit 50 may output information, which indicates that the first target and the second target have been correlated with each other, to the new target generation unit 60 or the second processing unit 70.

When it is determined that the second target is a recognized target, the first processing unit 50 allows the second distributor D2 to output the second target information input from the second recognition device 20 to the second processing unit 70, and when it is determined that the second target is not a recognized target, the first processing unit 50 allows the second distributor D2 to output the second target information input from the second recognition device 20 to the new target generation unit 60. In this case, the first processing unit 50 may output information, which indicates that the first target and the second target have been correlated with each other, to the new target generation unit 60 or the second processing unit 70.

The first processing unit 50 includes a determination part 50a. The determination part 50a determines whether the state of the first recognition device 10 or the second recognition device 20 is a predetermined state on the basis of the recognition results of the first recognition device 10 and the second recognition device 20 and a prediction result of a prediction part 74 of the second processing unit 70 to be described later. The predetermined state, for example, includes a state (for example, an axis deviation state) in which a mounting state of each of the first recognition device 10 and the second recognition device 20 is deviated from that assumed by the system.

When the target information is input from each distributor, the new target generation unit 60 outputs the input target information to the target information management unit 80, and outputs the target ID given to the target indicated by the target information to the target information management unit 80 as identification information of a new target.

The new target generation unit 60 includes an excess detection removal part 60a. The excess detection removal part 60a, for example, determines that there is no excess detection when the first target and the second target have been correlated with each other by the first processing unit 50, that is, when the first target and the second target are the same target. When the first target and the second target have not been correlated with each other by the first processing unit 50, that is, when the first target and the second target are not the same target, the excess detection removal part 60a may immediately determine that there is excess detection, or when a predetermined condition is satisfied, the excess detection removal part 60a may determine that there is excess detection as in a second embodiment to be described later.

For example, when it is not determined by the excess detection removal part 60a that the excess detection has occurred, the new target generation unit 60 outputs information on the first target indicated by the first target information and the second target indicated by the second target information to the target information management unit 80. The information on each target includes the first target information and the second target information when the first target and the second target have not been correlated with each other, and includes the common target ID, in addition to the first target information and the second target information, when the first target and the second target have been correlated with each other.

The second processing unit 70, for example, includes a derivation part 72 and a prediction part 74. The derivation part 72, for example, derives a position and a speed of a target on the basis of information output from the prediction part 74 and the information input from each distributor. For example, the derivation part 72 derives an average of the positions and the speeds of the first target and the second target correlated with each other as the same target and future position and speed of the target predicted by the prediction part 74. The derivation part 72 outputs the derivation result to the target information management unit 80.

The prediction part 74, for example, predicts future positions and speeds of the first target and the second target correlated with each other by using a time-series filter. The time-series filter, for example, is an algorithm for predicting a future state of an object (a target in the embodiment) to be observed by a Kalman filter, a particle filter and the like. For example, the prediction part 74 employs the latest derivation result of the derivation part 72 as input for the time-series filter, thereby acquiring a position and a speed derived by the time-series filter as a prediction result. The prediction part 74 outputs the prediction result of the future position and speed of the target to the first processing unit 50 and the derivation part 72.

The target information management unit 80, for example, stores the derivation result of the derivation part 72 in the storage unit 95 on the basis of the processing result of the new target generation unit 60, thereby managing the positions and the speeds of the first target and the second target correlated with each other as the same target, every recognition time.

The target information management unit 80 outputs the derivation result of the derivation part 72 to the time-series coordinate conversion unit 90 via the first buffer B1, and to an upper apparatus via the second buffer B2. The upper apparatus, for example, is an apparatus that automatically performs speed control and steering control of the host vehicle M or supports one or both of the speed control and the steering control by using the recognition result of the target recognition system 1.

The time-series coordinate conversion unit 90, for example, converts (corrects) the position of the target input from the target information management unit 80 via the first buffer B1, on the basis of the information input from the vehicle sensor 30. For example, the time-series coordinate conversion unit 90 coordinate-converts the position of the target on the virtual three-dimensional space, which has been obtained by the sensor fusion process, according to the amount of a temporal change in a relative distance and a relative speed between the target and the host vehicle M. The time-series coordinate conversion unit 90 outputs target information including the converted position to the prediction part 74.

[Processing Flow]

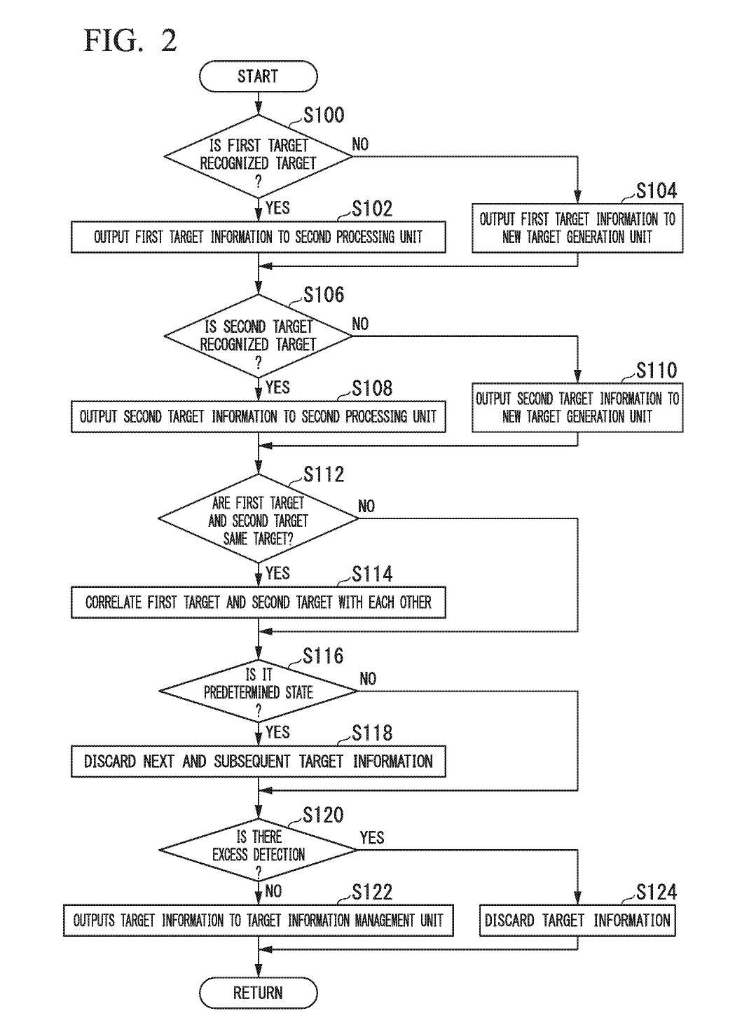

Hereinafter, a series of process of the target recognition system 1 will be described using a flowchart. FIG. 2 is a flowchart illustrating a series of processes of the target recognition system 1. The procedure of the present flowchart, for example, may be repeatedly performed at a predetermined cycle.

Firstly, the first processing unit 50 determines whether the first target indicated by the first target information is a recognized target (step S100). For example, the first processing unit 50 determines whether a difference between a position and a speed of the first target and a position and a speed of a target previously predicted by the prediction part 74 is in an allowable range, determines that the first target is the recognized target when the difference is in the allowable range, and determines that the first target is not the recognized target when the difference is out of the allowable range.

When it is determined that the first target is the recognized target, the first processing unit 50 controls the first distributor D1 to output the first target information to the second processing unit 70 (step S102). When it is determined that the first target is not the recognized target and is a new target, the first processing unit 50 controls the first distributor D1 to output the first target information to the new target generation unit 60 (step S104).

Next, the first processing unit 50 determines whether the second target indicated by the second target information is a recognized target (step S106). For example, the first processing unit 50 determines whether a difference between a position and a speed of the second target and the position and the speed of the target previously predicted by the prediction part 74 is in an allowable range, determines that the second target is the recognized target when the difference is in the allowable range, and determines that the second target is not the recognized target when the difference is out of the allowable range, similarly to the process (the process of S100) for determining whether the first target is the recognized target.

When it is determined that the second target is the recognized target, the first processing unit 50 controls the second distributor D2 to output the second target information to the second processing unit 70 (step S108). When it is determined that the second target is not the recognized target and is a new target, the first processing unit 50 controls the second distributor D2 to output the second target information to the new target generation unit 60 (step S110).

When one or both of the first target information and the second target information are input, the derivation part 72 of the second processing unit 70 derives the position and the speed of the target at a current time point on the basis of the position and the speed of one or both of the first target and the second target and the position and the speed of the target previously predicted by the prediction part 74. For example, the derivation part 72 derives, as the position and the speed of the target at the current time point, an average value and the like of the positions and the speeds of the targets included in the input target information and the position and the speed of the target previously predicted, and outputs the derivation result to the target information management unit 80.

Next, the first processing unit 50 determines whether the first target and the second target are the same target by comparing the first target information and the second target information with each other (step S112).

For example, the first processing unit 50 determines whether a difference between the position and the speed of the first target and the position and the speed of the second target is in an allowable range. When the difference between the position and the speed of the first target and the position and the speed of the second target is in the allowable range, the first processing unit 50 determines that the first target and the second target are the same target and gives a common target ID to the first target and the second target, thereby correlating these two targets with each other (step S114).

On the other hand, when it is determined that the difference between the position and the speed of the first target and the position and the speed of the second target is not in the allowable range, the first processing unit 50 omits the process of step S114.

Next, on the basis of the recognition results of both the first recognition device 10 and the second recognition device 20 and the prediction result of the prediction part 74 of the second processing unit 70, the determination part 50a of the first processing unit 50 determines whether the state of the first recognition device 10 or the second recognition device 20 is a predetermined state (step S116).

For example, when the first target and the second target are not the same target, one of them is the recognized target, and the other of them is the new target, the determination part 50a determines that a recognition device of the target determined as the new target is in the predetermined state.

When the first target and the second target are not the same target, the two targets are the recognized target or the new target, the determination part 50a determines that any one of the first recognition device 10 and the second recognition device 20 is in the predetermined state.

The first processing unit 50 decides to discard (remove) next and subsequent target information of the recognition device in the predetermined state (step S118). In this way, the correlating process of the targets of S112, S114 and the like is omitted. In this case, when any one recognition device is in the predetermined state, the prediction part 74 repeatedly predicts future position and speed of a target by using only the target information of the recognition device not in the predetermined state.

When it is not possible to distinguish whether which one recognition device is in the predetermined state, the first processing unit 50 may decide to discard next and subsequent target information of both recognition devices and end the procedure of the present flowchart.

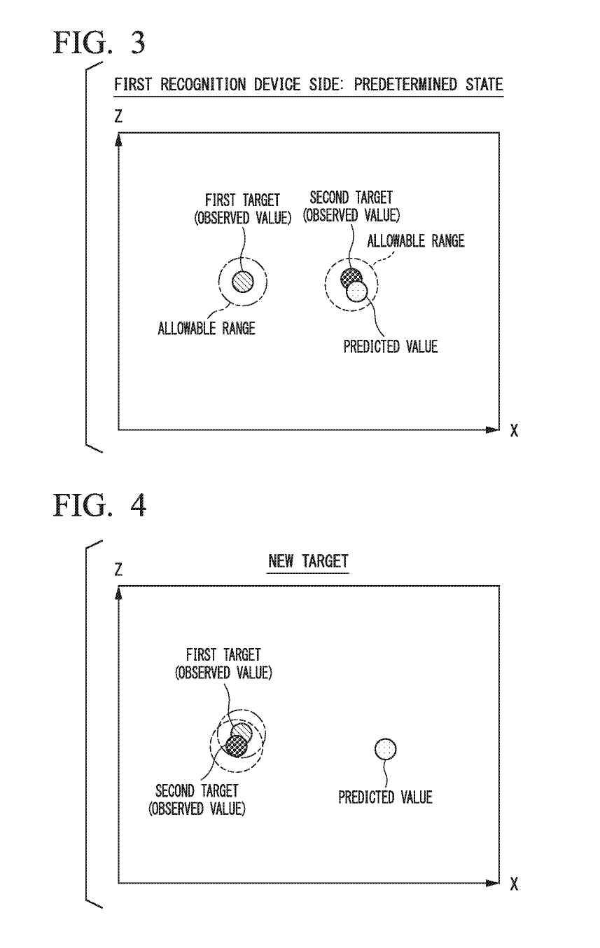

FIG. 3 is a diagram illustrating an example of a situation in which a recognition device is determined to be in a predetermined state. The illustrated example shows positions of each target on one plane (an x-z plane) on a virtual three-dimensional space (an x-y-z space). As illustrated in the example, when the second target does not exist in an allowable range employing the position of the first target as a reference and a prediction position exists in an allowable range employing the position of the second target as a reference, the determination part 50a determines that the first target is a new target and the second target is a recognized target. In this case, as illustrated in the example, when the first target and the second target are deviated from each other by the allowable range or more, the determination part 50a determines that the second recognition device 20 is not in the predetermined state and the first recognition device 10 is in the predetermined state.

FIG. 4 is a diagram illustrating an example of a situation in which the first target and the second target are determined as new targets. As illustrated in the example, when the second target exists in an allowable range employing the position of the first target as a reference but a prediction position does not exist in allowable ranges of the respective targets, the determination part 50a determines that the first target and the second target are the same target and the two targets are new targets.

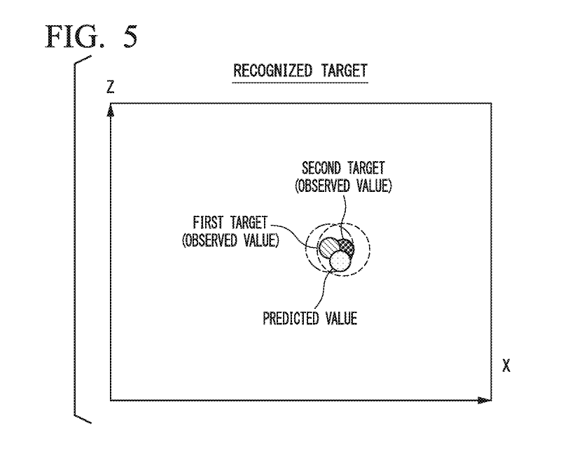

FIG. 5 is a diagram illustrating an example of a situation in which the first target and the second target are determined as recognized targets. For example, since the second target exists in an allowable range employing the position of the first target as a reference and a prediction position exists in allowable ranges of the respective targets, the determination part 50a determines that the first target and the second target are the same target and the two targets are recognized targets.

Next, when the target information is input from the recognition devices via each distributor, the excess detection removal part 60a of the new target generation unit 60 determines whether excess detection occurs in a recognition result of the first recognition device 10 or the second recognition device 20 according to whether the first target and the second target have been correlated with each other in the process of S114 (step S120).

For example, when the common target ID has been given and the first target and the second target have been correlated with each other, that is, when the first target and the second target are the same target, the excess detection removal part 60a determines that no excess detection has occurred. When the common target ID has not been given and the first target and the second target have not been correlated with each other, that is, when the first target and the second target are not the same target, the excess detection removal part 60a determines that the excess detection has occurred.

When it is determined that no excess detection has occurred, the new target generation unit 60 outputs the target information input from the recognition device to the target information management unit 80 (step S122). When the target information is received, the target information management unit 80 stores the target information of the new target in the storage unit 95. The target information management unit 80 outputs the target information of the new target to the time-series coordinate conversion unit 90 via the first buffer B1, and to an upper apparatus via the second buffer B2.

On the other hand, when it is determined that the excess detection has occurred, the new target generation unit 60 discards the target information input from the recognition device (step S124). In this way, the procedure of the present flowchart is ended.

The first embodiment described above includes the first recognition device 10 that recognizes a position and a speed of a target by using a reflected wave from the target, the second recognition device 20 that recognizes a position and a speed of a target by using at least a part of an outline of the target, the first processing unit 50 that determines whether the target recognized by the first recognition device 10 and the target recognized by the second recognition device 20 are the same target and correlates the targets determined as the same target with each other when the targets are determined as the same target, the prediction part 74 that predicts future positions and speeds of the targets correlated with each other by the first processing unit 50, and the determination part 50a that determines whether the state of the first recognition device 10 or the second recognition device 20 is a predetermined state on the basis of the prediction result of the prediction part 74 and the recognition results of the first recognition device 10 and the second recognition device 20, so that it is possible to improve accuracy of recognition of a target while improving a processing speed.

For example, the determination part 50a performs a process in the same stage as that of the first processing unit 50, so that it is not necessary to perform a process in a subsequent stage of the derivation part 72 and thus a processing speed is improved. When the determination part 50a determines whether each recognition device is in a predetermined state, it is not necessary to use a recognition result of a recognition device in a state originally unusable for a recognition device due to axis deviation and the like, so that it is possible to improve accuracy of recognition of a target.

According to the aforementioned first embodiment, when excess detection has occurred, since the excess detection removal part 60a discards target information, it is possible to exclude a position and a speed of a target determined as the excess detection from input to the time-series filter of the prediction part 74. As a consequence, even when a position and a speed of a target is temporarily deviated from recognition results up to now due to the occurrence of the excess detection, the target information is not reflected in a next prediction process, so that it is possible to accurately continue to recognize a target.

### Second Embodiment

Hereinafter, a second embodiment will be described. The second embodiment is different from the aforementioned first embodiment in that, when the host vehicle M travels along a predetermined section in which excess detection has been determined in advance to easily occur, the excess detection removal part 60a operates in the predetermined section and does not operate in sections other than the predetermined section. Hereinafter, the difference with the first embodiment will be mainly described and functions and the like common to the first embodiment will not be described.

[System Configuration]

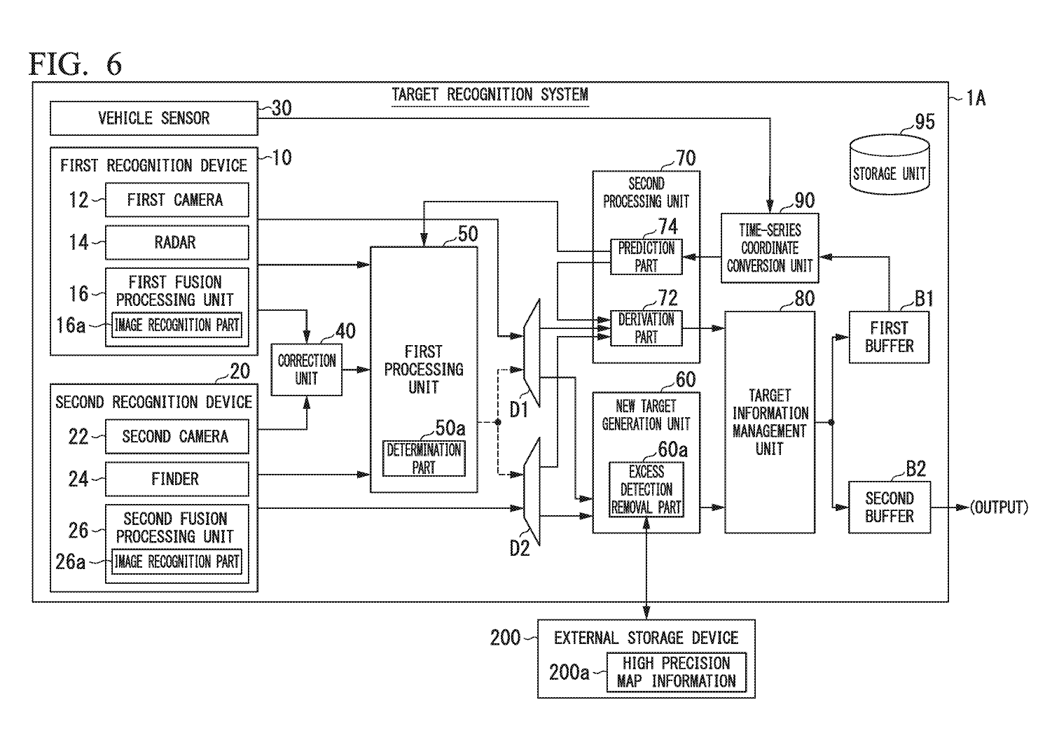

FIG. 6 is a configuration diagram of a target recognition system 1A of the second embodiment. The excess detection removal part 60a of the target recognition system 1A of the second embodiment, for example, communicates with an external storage device 200 in a wired manner or a wireless manner, and refers to high precision map information 200a stored in the external storage device 200. The high precision map information 200a, for example, includes information on the center of a lane, information on the boundary of a lane, and the like. The high precision map information 200a includes information indicating the type of a road such as an expressway, a toll road, a national highway, and a prefectural road, and information indicating a reference speed of a road, the number of lanes, widths of each lane, a slope of a road, a position (a three-dimensional coordinate including a longitude, a latitude, and a height) of a road, a curvature of a curve of a road or each lane of the road, positions of merging and branch points of a lane, signs provided on a road, and the like.

For example, the excess detection removal part 60a determines whether a predetermined section exists on a scheduled route along which the host vehicle M travels with reference to the high precision map information 200a. The predetermined section is a section in which excess detection easily occurs as described above, and for example, is a section in which there exists a road information bulletin board displaying road surface freezing and traffic jam information of a road, and impact attenuators provided to merging and branch points of a lane. For example, when the predetermined section exists on a road and the host vehicle M has reached the predetermined section, the excess detection removal part 60a starts an excess detection determination process. On the other hand, when the host vehicle M has not reached the predetermined section or the predetermined section does not exist on the scheduled route, the excess detection removal part 60a stops the excess detection determination process. As described above, since the excess detection determination process is performed only for a section in which excess detection has been determined in advance to easily occur, it is possible to suppress unnecessary excess detection determination, so that it is possible to further improve the accuracy of recognition of a target.

When the presence or absence of excess detection is determined on the basis of a predetermined index value such as probability and reliability, the excess detection removal part 60a of the second embodiment may perform the excess detection determination by changing a threshold value for the index value in the predetermined section and sections other than the predetermined section. For example, the excess detection removal part 60a comprehensively determines target information output from the first recognition device 10 or the second recognition device 20, and a determination result of the determination part 50a of the first processing unit 50, and derives an index value indicating the degree of occurrence of excess detection. When the index value is equal or more than the threshold value, the excess detection removal part 60a determines that there is the excess detection. In this case, in the excess detection removal part 60a, the threshold value for the index value is decreased in the predetermined section, it is easy to determine the excess detection, and the threshold value is increased in other sections, it is hard to determine the excess detection. In this way, it is possible to suppress unnecessary excess detection determination, so that it is possible to further improve the accuracy of recognition of a target.

According to the second embodiment described above, since it is easy to determine the excess detection in a section in which the excess detection easily occurs and it is hard to determine the excess detection in the other sections, it is possible to suppress unnecessary excess detection determination. As a consequence, it is possible to further improve the accuracy of recognition of a target.

While preferred embodiments of the invention have been described and illustrated above, it should be understood that these are exemplary of the invention and are not to be considered as limiting. Various modifications and additions can be made without departing from the spirit or scope of the present invention.

What is claimed is:

1. A target recognition system comprising:
a first recognition device configured to recognize a position and a speed of a target;
a second recognition device configured to recognize a position and a speed of a target and to be different from the first recognition device;
a first processing unit configured to determine whether a first target recognized by the first recognition device and a second target recognized by the second recognition device are the same target, and to correlate the first target and the second target with each other when it is determined that the first target and the second target are the same target; and
a second processing unit configured to predict future positions and speeds of the first target and the second target correlated with each other by the first processing unit,
wherein the first processing unit determines whether a state of the first recognition device or the second recognition device is a predetermined state on the basis of a prediction result of the second processing unit and recognition results of the first recognition device and the second recognition device.

2. The target recognition system according to claim 1, wherein the first processing unit determines whether the recognition results of the first recognition device and the second recognition device coincide with the prediction result of the second processing unit, and
when any one of the recognition results of the first recognition device and the second recognition device does not coincide with the prediction result of the second processing unit, the first processing unit determines that a recognition device, which has the recognition result not coinciding with the prediction result of the second processing unit, is in the predetermined state.

3. The target recognition system according to claim 1, wherein, on the basis of a prediction result of the second processing unit at a first timing and recognition results of the first recognition device and the second recognition device at a second timing after the first timing, the second processing unit further derives a speed and a position of a target recognized at the second timing, and
the target recognition system further comprises:
an information management unit configured to store a derivation result of the second processing unit in a storage unit according to a determination result of the first processing unit, and
on the basis of information stored in the storage unit by the information management unit, the second processing unit predicts future position and speed of the target recognized at the second timing.

4. The target recognition system according to claim 1, wherein, when it is determined by the first processing unit that any one of the first recognition device and the second recognition device is in the predetermined state, the second processing unit predicts future position and speed of the target on the basis of a recognition result of a recognition device determined not to be in the predetermined state.

5. The target recognition system according to claim 1, wherein the first recognition device comprises:
a camera;
an image recognition part configured to recognize a target by analyzing an image of the camera; and
a radar configured to recognize a target on the basis of an electromagnetic wave reflected by the target,
wherein the first recognition device outputs, to the first processing unit, a position and a speed of a target determined as the same target between the targets recognized by the image recognition part and the radar.

6. The target recognition system according to claim 1, wherein the second recognition device comprises:
a camera;
an image recognition part configured to recognize the target by analyzing an image of the camera; and
a finder configured to recognize the target on the basis of a reflected wave of light projected to the target, the reflected wave being reflected by the target,
wherein the second recognition device outputs, to the first processing unit, a position and a speed of a target determined as the same target between the targets recognized by the image recognition part and the finder.

7. A target recognition method causing an in-vehicle computer, which is installed in a vehicle including a first recognition device that recognizes a position and a speed of a target and a second recognition device that recognizes a position and a speed of a target and is different from the first recognition device, to perform:
determining whether a first target recognized by the first recognition device and a second target recognized by the second recognition device are the same target;
correlating the first target and the second target with each other when it is determined that the first target and the second target are the same target;
predicting future positions and speeds of the first target and the second target correlated with each other; and
determining whether a state of the first recognition device or the second recognition device is a predetermined state on the basis of a prediction result of the future positions and speeds of the first target and the second target and recognition results of the first recognition device and the second recognition device.

8. A storage medium stored with a program causing an in-vehicle computer, which is installed in a vehicle including a first recognition device that recognizes a position and a speed of a target and a second recognition device that recognizes a position and a speed of a target and is different from the first recognition device, to perform:
a step of determining whether a first target recognized by the first recognition device and a second target recognized by the second recognition device are the same target;
a step of correlating the first target and the second target with each other when it is determined that the first target and the second target are the same target;
a step of predicting future positions and speeds of the first target and the second target correlated with each other; and
a step of determining whether a state of the first recognition device or the second recognition device is a predetermined state on the basis of a prediction result of the future positions and speeds of the first target and the second target and recognition results of the first recognition device and the second recognition device.
